(19) United States
(12) Patent Application Publication
(10) Pub. No.: US 2010/0057229 A1
(43) Pub. Date: Mar. 4, 2010

(54) ReciPC

(76) Inventors: Zetra Marie Batiste, Vahingen (DE); Stephanie Ann Dantzler, Vaihingen (DE)

Correspondence Address: Zetra M. Batiste, DISA Europe Unit 30403 Box 46, APO, AE, 09131, US

(21) Appl. No.: 12/284,554

(22) Filed: Sep. 19, 2008

Related U.S. Application Data
(60) Provisional application No. 60/960,220, filed on Sep. 20, 2007.

(51) Int. Cl. G06F 17/00

(52) U.S. Cl. 700/94

(57) ABSTRACT

Following recipes or paper formatted instructions has not evolved with current technology. In a digital age, technology enhances how we prepare, share and quickly access information from virtually anywhere.

Using the ReciPC concept allows users to do new and innovative things with recipes and instructional guides. Users are no longer limited to reading directions from a cookbook or instructions from a manual. Incorporating technological enhancements such as audio, scrolling text, video, and 3 Dimensional personalized training (holograms) gives manuals and cookbooks a modern day facelift. In addition, integrating media devices with the ReciPC into kitchen appliances and furniture will revolutionize how recipes or instructions are followed.

This application claims the benefit of provisional patent application Ser. No. 60/960,220, file date, Sep. 20, 2007.

BE IT KNOWN THAT WE, Zetra M. Batiste, a citizen of the U.S. and Stephanie A. Dantzler, a citizen of the U.S., have developed a new, innovative way of utilizing video capable multimedia players, referred hereafter as media players. The ReciPC concept will drive the demand up for media players to people and markets that normally wouldn't use one. The concept of ReciPC will charge the current media player market by placing media devices in more homes and businesses.

### FIELD OF THE INVENTION

ReciPC will revolutionize the way in which people prepare, share, and store recipes or step by step instructional information . . . making it the ultimate kitchen, self help, or business companion.

Media players, using this concept will provide cooks, chefs, and those following recipes (or instructional media) with easy access to their recipes in either audio, text, or video format (including 3D hologram). Gone are the days of following recipes in paper format. This device will also have the capability of providing the recipe follower with serving size adjustments and temperature, measurement and language conversions, to include a substitution feature, equivalency chart, calorie counter and cooking tips.

A wireless internet connection allows the user to download recipes from various online recipe sharing websites or emailing your favorite recipe to friends. Businesses are able to quickly share recipes across franchises. Users of ReciPC have the capability to load recipes on to the media player via voice recording or text format. In addition, scanning recipes or uploading a text file can easily be transferred to the device. Recipes are easily followed through text displayed on the device screen, verbally instructed via Text-To-Speech technology (TTS), or by watching a hologram or regular video feed.

### DESCRIPTION OF THE RELATED ART

Currently, media players devices caters to a large market-base offering the consumer the capability to listen to hours of music, read books, watch movies, videos, or television shows virtually anywhere. This technology has revolutionized the manner in which we dynamically relax. No longer just for music lovers, ReciPC is a new way to target a larger audience and expand sales to an extended demographic market—revolutionizing how the world prepares, shares, and stores recipes making the old “cookbook” methodology obsolete creating a clutter-free environment. Play and record all of your instructional cooking videos and TV shows directly from the device. Surf the web and access online recipes and instructional video websites.

### OBJECTS AND ADVANTAGES

ReciPC will target a new audience made available to homeowners, business owners, chefs, and entrepreneurs by utilizing the multimedia player device. The recipe industry (cooks, chefs, restaurant, bar, health & beauty, spa, household cleaning, and pharmaceutical industries (basically anything that entails a set of directions)) will transform the way in which recipes are prepared, shared, and stored. In addition, custom homebuilders can install the ReciPC device as an upgrade to their kitchen appliances. Homeowners can incorporate into building or remodeling plans. By teaming up with major appliance (ranges, refrigerators, cabinets, work-benches) vendors, the ReciPC device will be made available in every household and restaurant.

### SUMMARY OF THE INVENTION

This is not a new invention. This ReciPC concept is merely enhancing a multimedia player device with preexisting technology. The ReciPC concept pulls together existing technologies and tools to provide the user with a device that will modernize how the world prepares shares and stores recipes. ReciPC makes the old cookbook in paper format obsolete by utilizing audio and video to assist you in following instructions. This portable device provides the user flexibility in where and how they share. Bringing your list of recipe ingredients to your supermarket is no longer necessary. The device provides the recipe ingredients, access to substitutions if ingredients are not available, and provides an equivalency chart to determine the yield from food quantities. In addition, using the video display allows the user to follow their favorite chefs step-by-step instructions as they prepare their favorite meals at the user's tempo. Incorporating this device into kitchen ranges will target appliance vendors and homeowners to incorporate into their building and remodeling plans. This device will catapult the recipe and appliance industry into an untouched market.

The ReciPC is intended for use with any multimedia player device. If the consumer requires audio and video recording capability, the selected device of choice would have to support that feature. Using existing technology associated with multimedia players and mounting the devices where instructions are to be followed, expands the functionality of the device making it more appealing to more than just an entertainment audience. All multimedia devices have a text feature and afford the user to the capability to upload files which eliminates makes using paper cookbooks obsolete in this technology era. The video capability that exist with all devices give recipe followers frame by frame how to instructions utilizing 3 D hologram technology or standard video. Wireless capability exists affording the user the opportunity to send and receive recipes.

### DESCRIPTION OF THE DRAWINGS

FIG. 1 depicts a media device mounted on a stove (range).

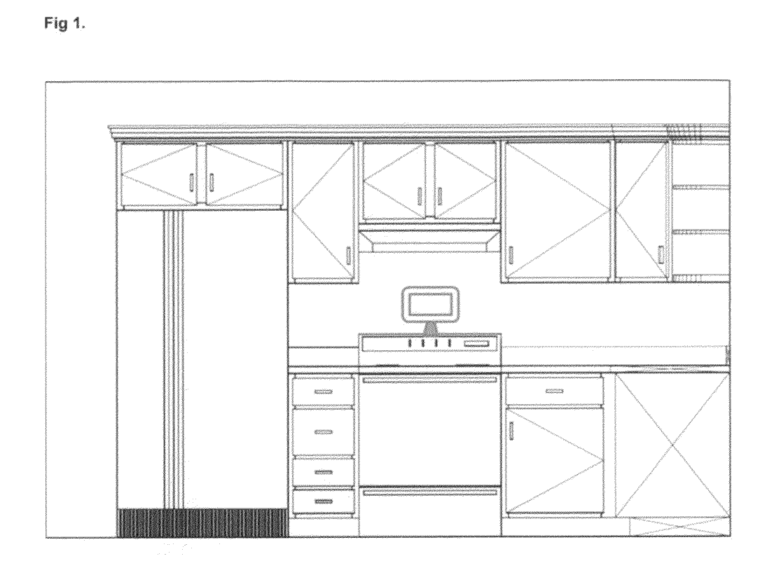

FIG. 2 shows the media device mounted under the kitchen cabinets allowing for easy viewing close to the food preparation area.

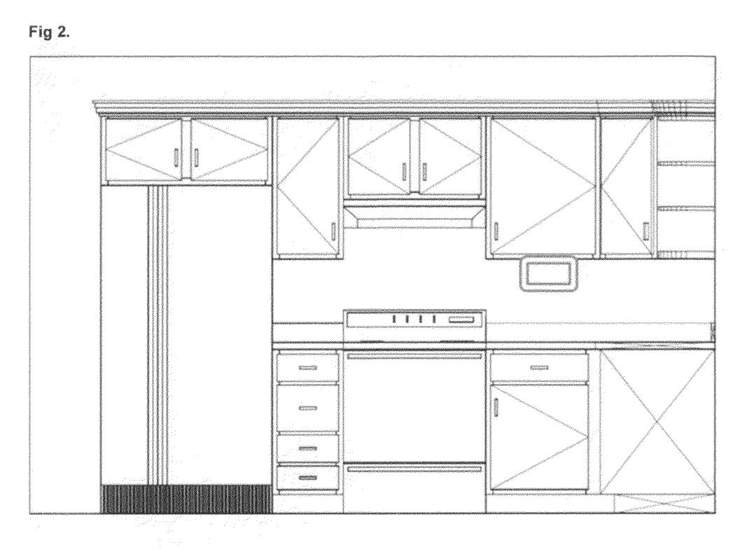

FIG. 3 shows the media device mounted on a refrigerator.

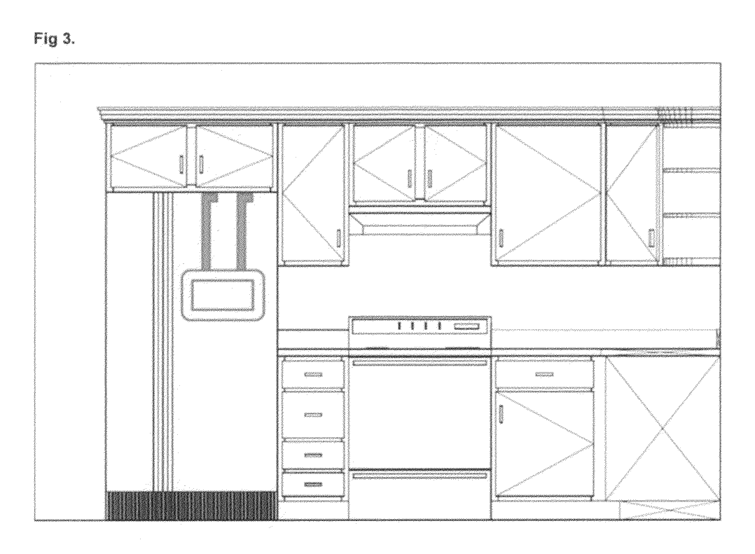

FIG. 4 represents perspective views of media devices according to an illustrative embodiment of existing inventions.

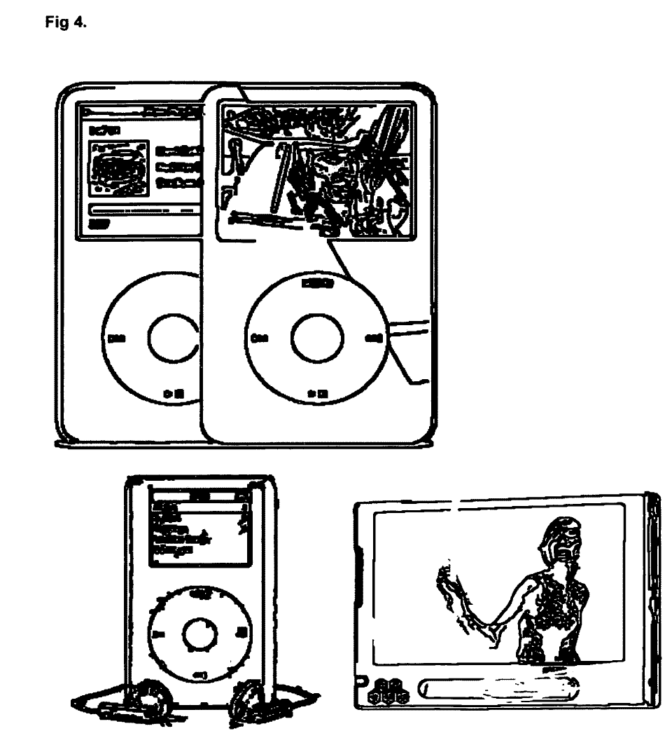

FIG. 5 shows the media device using ReciPC built in to a work bench.

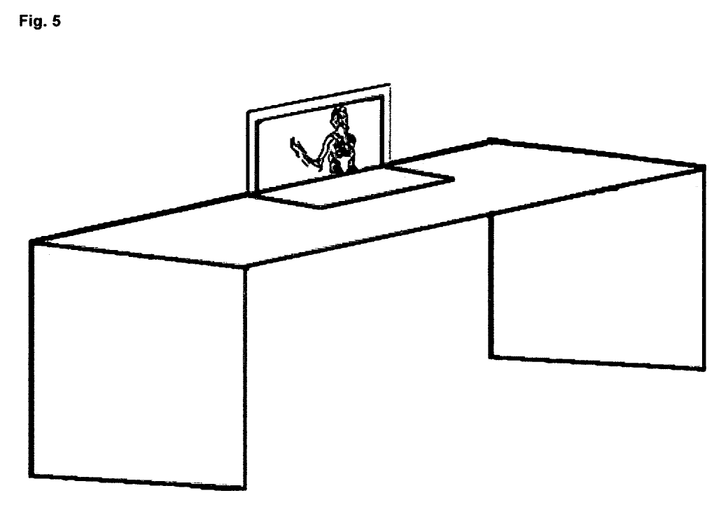

The ReciPC can use any multimedia player compromised (but not limited to) the specifications listed below:
Capacity: 40 GB (or greater) hard drive
High Definition Display: varying (preferred 7″ TFT Touch screen (800×480 pixels) or greater)
Video playback: MPEG4 (ASP@L5 AVI, up to DVD resolution)
WMV (MP@ML, up to DVD resolution).
Audio playback: Stereo MP3 decoding @ 30-320 Kbits/s CBR & VBR, WMA, Protected WMA, WAV (PCM/ADPCM).
Photo viewer: JPEG, BMP, PNG
PDF viewer: Reads PDF documents (may not implement all PDF features)
Video recording: optional. Records NTSC/PAL/SECAM to MPEG-4 SP files with ADPCM stereo sound, VGA resolution (640×480)@ 30 or 25 f/s, in AVI format.
Audio recording: Via the stereo line-in, WAV (IMA ADPCM or PCM) format
Interfaces: USB 2.0 High-Speed Device: Mass Storage Class (MSC) and Media Transport Protocol (MTP).
USB 2.0 Host: Mass Storage Class (MSC) and Picture Transfer Protocol (PTP)
Battery life: varying degree for Music and video playback time:
Power source: Internal: Removable Lithium-Ion Polymer battery.
External: Power adapter/charger
Scalability: capability to download firmware updates
Dimensions & weight: varying
Hologram capability: High Definition 3D projector

1. An innovative concept (ReciPC) using media players to follow recipes or instructions, the concept comprises:
1) Use of high definition display enabling hologram video technology for personalized 3 dimensional instructions; and
2) A vehicle for audio, video, and scrolling text to follow recipes/instructions; and
3) A device with a database offering an array of substitutions or ingredient alternatives, temperature conversion, all in various languages; and
4) Wi-Fi capability for retrieving recipes/instructions from the Internet and sharing recipes/instructions via email; and
5) Installation of media players using ReciPC in kitchen cabinets, appliances (stoves, refrigerators), work-benches, or carried on the go
